(19) United States
(12) Patent Application Publication
(10) Pub. No.: US 2026/0249539 A1
(43) Pub. Date: Aug. 27, 2026

(54) CONTAINER PREFORM MADE OF PLASTICS MATERIAL

(71) Applicant: SIDEL PARTICIPATIONS, Octeville-sur-Mer (FR)

(72) Inventors: Mickaël LETESTU, OCTEVILLE- SUR-MER (FR); Michel BOUKOBZA, OCTEVILLE- SUR-MER (FR); Mikaël DERRIEN, OCTEVILLE- SUR-MER (FR)

(21) Appl. No.: 19/548,330

(22) Filed: Feb. 24, 2026

(30) Foreign Application Priority Data
Feb. 26, 2025 (FR) 2501977
Jun. 30, 2025 (FR) 2507274

(51) Int. Cl. B29C 49/00; B29C 49/64

(52) U.S. Cl. CPC B29C 49/071; B29C 49/6418; B29C 2949/0723

(57) ABSTRACT

Disclosed are embodiments of a plastic preform for manufacturing containers by stretch-blow molding. The preform body is rotationally symmetrical about a vertical central axis and has an outer and an inner wall, the radial distance therebetween defining a wall thickness. The wall thickness increases from a collar towards a base over a cone height Hc, where cone height Hc is the mean of cone height Hc₁ of the outer wall and cone height Hc₂ of the inner wall. The body has a first wall thickness E2 under the collar at an under-neck reference height Hr, a second wall thickness E at cone height Hc, and a third wall thickness E1 at the lower end of the body, where E1 is between 0.7 E and 1.2 E and E2 is between 0.5 E and 1.0 E. E corresponds to the greatest wall thickness at the cone height Hc₁ or Hc₂.

### CROSS-REFERENCE TO RELATED APPLICATIONS

This application claims the benefit of and priority to French Application No. FR 2501977, filed Feb. 26, 2025, and also claims the benefit of and priority to French Application No. FR 2507274, filed on Jun. 30, 2025. The complete disclosure of each of the foregoing priority applications are hereby fully incorporated herein by reference.

### BACKGROUND

Containers typically comprises a lateral wall which is generally rotationally symmetrical about a central axis, a neck which extends as a continuation of the lateral wall and through which the container is intended to be filled and emptied, and a base which extends transversely from a lower end of the body and by which the container is intended to rest on a flat surface. Furthermore, a preform typically comprises a substantially cylindrical body (intended to form the lateral wall of the container), an open neck which extends as a continuation of the body from an upper end thereof and is separated from the body by a collar (the neck remaining unchanged during the container forming process), and a base which closes the body at a lower end thereof (and is intended to form the base of the container).

To form the container from the preform, the body and the base of the preform are first heated to a temperature above the glass transition temperature of the material (which, for PET, is about 72° C. to 75° C.). A pressurized fluid (typically air) is then injected into the preform, the body of which undergoes both axial and radial expansion until it reaches the desired shape of the container body. Generally, the axial expansion is facilitated by stretching with the help of a stretching rod.

Said heating is generally carried out in a heating unit (also called an oven) equipped with a plurality of infrared radiation sources to which the preforms are exposed. These sources are generally halogen lamps, which emit over a relatively wide spectrum including short-wave infrared (and possibly part of the medium-wave infrared), as well as at least part of the visible spectrum. The main drawbacks of halogen lamps are their low (or even non-existent) directivity and their relatively short service life.

New laser oven technologies improve over halogen heating technologies. Numerous tests of this new technology carried out on preforms of all shapes and sizes have shown that the heating of the preforms can also be improved by developing preform shapes different from those known and used in halogen oven technology. It has therefore become apparent that the silhouette and dimensions of the preforms need to be reworked.

Accordingly, it has been found that needs exist for improved preforms for use with laser oven heating. It is to the provision of meeting these and other needs that the present disclosure is primarily directed.

### SUMMARY

Embodiments of the present disclosure provide for a preform having a body that is rotationally symmetrical about a vertical central axis, the body having an outer wall and an inner wall, a radial distance between the outer wall and the inner wall defining a wall thickness. The preform also includes an open neck that extends as a continuation of the body from an upper end thereof, the neck being separated from the body by an annular collar. The preform also has a base that closes the body from a lower end thereof, the base being rotationally symmetrical about the central axis. The body has a substantially cylindrical shape in which the wall thickness increases from the collar towards the base over a cone height Hc, the cone height Hc being a mean of a cone height Hc1 of the outer wall of the body and a cone height Hc2 of the inner wall of the body. The body includes a first wall thickness E2 under the collar at an under-neck reference height Hr, a second wall thickness E of at the cone height Hc, and a third wall thickness E1 at the lower end of the body. The third wall thickness E1 is between 0.7 E and 1.2 E and such that the first wall thickness E2 is between 0.5 E and 1.0 E, wherein the second wall thickness E corresponds to the greatest thickness of the wall of the body at the cone height Hc1 or Hc2.

An embodiment of the present disclosure includes a method for manufacturing a container by blow molding or stretch-blow molding, the method including providing a preform as above, heating the body of the preform by exposure to monochromatic or quasi-monochromatic infrared radiation of predetermined intensity to form a preheated preform, and forming the container by injecting a pressurized fluid into the preheated preform.

An embodiment of the present disclosure also includes a mold for forming a preform as described above.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is an elevational sectional view of a preform for manufacturing a container, according to various example embodiments;

FIG. 2 is a schematic representation illustrating the manufacture of a container from a preform according to various example embodiments; and

FIG. 3 is a sectional view of a mold used to form the preform according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

### General Discussion

n general, embodiments of the present disclosure provide for manufacture of containers from preforms made of plastics material, notably polyethylene terephthalate (PET) and/or recycled polyethylene terephthalate (rPET). More precisely, the disclosure relates to a preform intended for forming a container by blow molding or stretch-blow molding, within a mold with the impression of the container or freely (i.e. without a mold).

To overcome the drawbacks of halogen forming, Applicant has developed an alternative heating technology based on the use of monochromatic (or quasi-monochromatic) radiation sources, which offer better directivity and a longer service life; see, for example, European patent application EP 2 720 842 (Sidel Participations), which describes a method for heating preforms by means of an array of vertical-cavity surface-emitting laser diodes (VCSELs).

Numerous tests of this new technology, called laser oven, carried out on preforms of all shapes and sizes, have shown that the heating of the preforms can also be improved by developing preform shapes different from those known and used in halogen oven technology. It has therefore become apparent that the silhouette and dimensions of the preforms need to be reworked.

In this respect, the Applicant has already proposed a preform which, when exposed to monochromatic or quasi-monochromatic infrared radiation, can be heated in a relatively uniform manner, i.e. without exhibiting undesired local overheating zones. A preform of this kind adapted to a laser oven is described in particular in document WO2017/103372 A1 filed by the Applicant.

The aforementioned document WO2017/103372 A1 describes a container preform made of plastics material comprising a body which is rotationally symmetrical about a central axis; an open neck which extends as a continuation of the body and is separated therefrom by a radially projecting collar; and a base which closes the body opposite the neck; wherein the body has a concave portion in axial section and in which: B≤0.9 A and 0.5 C<C′<0.95 C, where A is the overall diameter of the body, measured beneath the collar; B is the external diameter of the base, measured at its junction with the body; C is the combined height of the body and the base, measured from the collar; C′ is the height, measured axially, of the concave portion of the body, and the concave portion has, in axial section, on an outer face, an external radius of curvature RE such that 1.5 C≤RE≤10 C.

These features help to minimize refraction within the material, thereby improving the quality of heating.

However, these preforms are not optimized for all sizes of packaging formats and all types of necks to enable an ideal fit with the packaging, notably in the case of significant lightweighting, while being compatible with the rules and constraints related to injection of the preforms. Thus, these preforms do not allow a satisfactory distribution of material to be obtained for all container formats and, ultimately, do not permit lightweighting of the containers manufactured from these preforms, while ensuring, in particular, good quality of said containers.

One object of the disclosure is therefore to remedy all or some of these drawbacks by providing a preform of simple and inexpensive design, which is particularly suitable for heating in a laser oven and provides improved material distribution for all container formats, thereby allowing lightweighting of the containers manufactured from this preform, while in particular ensuring good quality of said containers.

For this purpose, and according to the disclosure, a preform is proposed for manufacturing containers by stretch-blow molding, from plastics material, comprising at least a body which is rotationally symmetrical about a vertical central axis (X), said body having an outer wall and an inner wall, the radial distance between the outer wall and the inner wall defining a wall thickness, an open neck which extends as a continuation of the body from an upper end thereof, said neck being separated from the body by an annular collar, and a base which closes the body from a lower end thereof, said base being rotationally symmetrical about the central axis (X), which is noteworthy in that said body has a substantially cylindrical shape in which the thickness of the wall increases from the collar, the thickness of the wall of the body under the collar being equal to E2 at an under-neck reference height Hr, towards the base over a cone height Hc, said cone height Hc being the mean of the cone height Hc1 of the outer wall of the body and the cone height Hc2 of the inner wall of the body, the thickness of the wall of the body at said cone height Hc being equal to E and the thickness of the wall of the body at the lower end of said body being equal to E1, such that the thickness E1 is between 0.7 E and 1.2 E and that the thickness E2 is between 0.5 E and 1.0 E, wherein the thickness E corresponds to the greatest thickness of the wall of the body at the cone height Hc1 or Hc2.

Advantageously, the under-neck reference height Hr is between 1.0 E2 and 4.0 E2 .

Furthermore, over the cone height Hc, the mean external diameter D1 of the body increases from the collar towards the lower end of the body.

Furthermore, over the height Hc, the mean internal diameter D2 of the body is constant from the collar towards the lower end of the body.

According to a variant embodiment of the preform according to the disclosure, over the cone height Hc, the mean external diameter D1 of the body is constant from the collar towards the lower end of the body and, over said cone height Hc, the mean internal diameter D2 of the body decreases from the collar towards the lower end of the body.

In addition, the base of the preform has a substantially hemispherical shape.

Preferably, said base has a wall thickness less than or equal to the thickness E1 of the body of the preform.

Another aspect of the disclosure relates to a method for manufacturing a container by blow molding or stretch-blow molding, comprising at least the following steps: providing a preform according to the disclosure; heating the body of the preform by exposure to monochromatic or quasi-monochromatic infrared radiation of predetermined intensity; and forming the container by injecting a pressurized fluid into the preform preheated in this way.

Furthermore, the method comprises, between the heating step and the forming step, a step of introducing the preform into a mold with the impression of the container.

Another aspect of the disclosure relates to a mold for forming a preform according to the disclosure, comprising a mold body having a lateral wall with the impression of an outer face of the body of the preform and a mold base with the impression of an outer face of the base of the preform and a core with the impression of an inner face of the preform.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Turning now to the drawings, exemplary embodiments are described in detail.

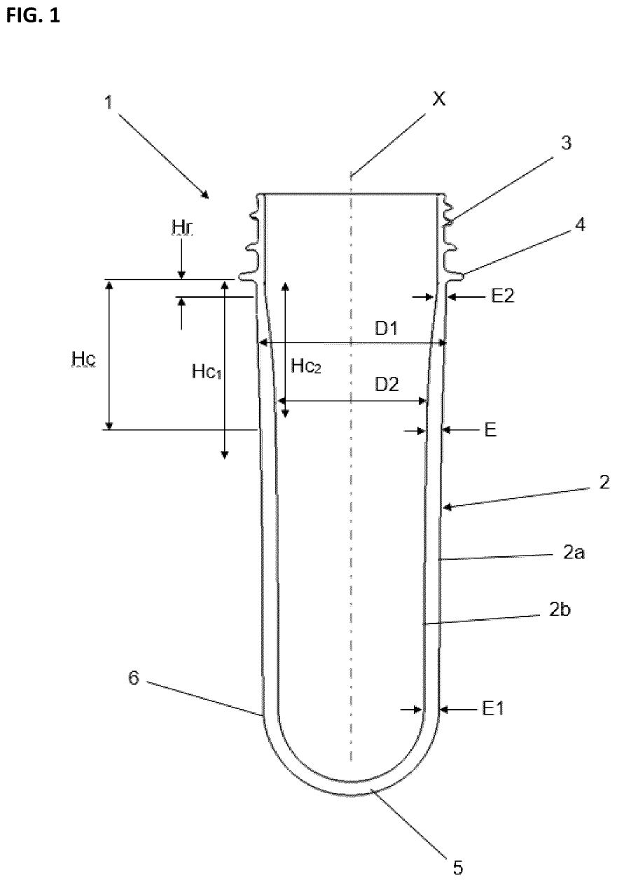

FIG. 1 shows a preform 1 made of plastics material such as PET (polyethylene terephthalate) and/or rPET (recycled polyethylene terephthalate), from which a container is intended to be formed by blow molding or stretch-blow molding.

Each preform 1 comprises, firstly, a body 2 which extends in a rotationally symmetrical manner about a central axis X. According to an advantageous embodiment suitable for most applications, the body 2 is substantially cylindrical. The body 2 of the preform 1 is intended to form a body and a shoulder of the container.

Each preform 1 comprises, secondly, an open neck 3 which extends as a continuation of the body 2 from an upper end thereof. The neck 3 has its final shape, which it is intended to retain throughout the forming process and service life of the container.

The neck 3 is advantageously separated from the body 2 by a collar 4 projecting radially, by which the preform 1 (and subsequently the container) is suspended (or more generally held) during various operations including conveyance, heating of the preform 1 or formation of the container, as well as, respectively, filling, capping and labelling of the preform, wherein labelling can be carried out before filling.

Each preform 1 comprises, thirdly, a base 5 which closes the body 2 from a lower end 6 thereof, i.e. the material of the base 5 extends from the lower end 6 of the (substantially cylindrical) body 2 radially towards the central axis X so as to close the preform 1 opposite the neck 3. The base 5 is rotationally symmetrical about the central axis X, i.e. it is invariant in any longitudinal sectional plane (in other words, any plane passing through the central axis X).

Hence, said preform 1 according to the disclosure for manufacturing containers by stretch-blow molding, from plastics material, comprises at least a body 2 which is rotationally symmetrical about a vertical central axis (X), said body 2 having an outer wall 2a and an inner wall 2b, the radial distance between the outer wall 2a and the inner wall 2b defining a wall thickness, an open neck 3 which extends as a continuation of the body 2 from an upper end thereof, said neck 3 being separated from the body 2 by an annular collar 4, and a base 5 which closes the body 2 from a lower end 6 thereof, said base 5 being rotationally symmetrical about the central axis (X).

Said body 2 has a substantially cylindrical shape in which the thickness of the wall increases from the collar, the thickness of the wall of the body under the collar being equal to E2 at an under-neck reference height Hr, towards the base over a cone height Hc, said cone height Hc being the mean of the cone height Hc1 of the outer wall 2a of the body 2 and the cone height Hc2 of the inner wall 2b of the body 2, the thickness of the wall of the body 2 at said cone height Hc being equal to E and the thickness of the wall of the body at the lower end of said body being equal to E1, such that the thickness E1 is between 0.7 E and 1.2 E and that the thickness E2 is between 0.5 E and 1.0 E, wherein the thickness E corresponds to the greatest thickness of the wall of the body at the cone height Hc1 or Hc2.

Advantageously, the under-neck reference height Hr is between 1.0 E2 and 4.0 E2.

Furthermore, over the cone height Hc, the mean external diameter D1 of the body 2 increases from the collar 4 towards the lower end 6 of the body 2.

Furthermore, over the height Hc, the mean internal diameter D2 of the body 2 is constant from the collar 4 towards the lower end 6 of the body 2.

According to a variant embodiment of the preform according to the disclosure, not shown in the figures, over the cone height Hc, the mean external diameter D1 of the body 2 is constant from the collar 4 towards the lower end 6 of the body 2 and the mean internal diameter D2 of the body 2 decreases from the collar 4 towards the lower end 6 of the body 2.

In addition, the base 5 of the preform 1 has a substantially hemispherical shape.

Preferably, said base has a wall thickness less than or equal to the thickness E1 of the body of the preform.

It is clearly understood that the base 5 of the preform 1 may have any shape and any thickness without thereby departing from the scope of the disclosure.

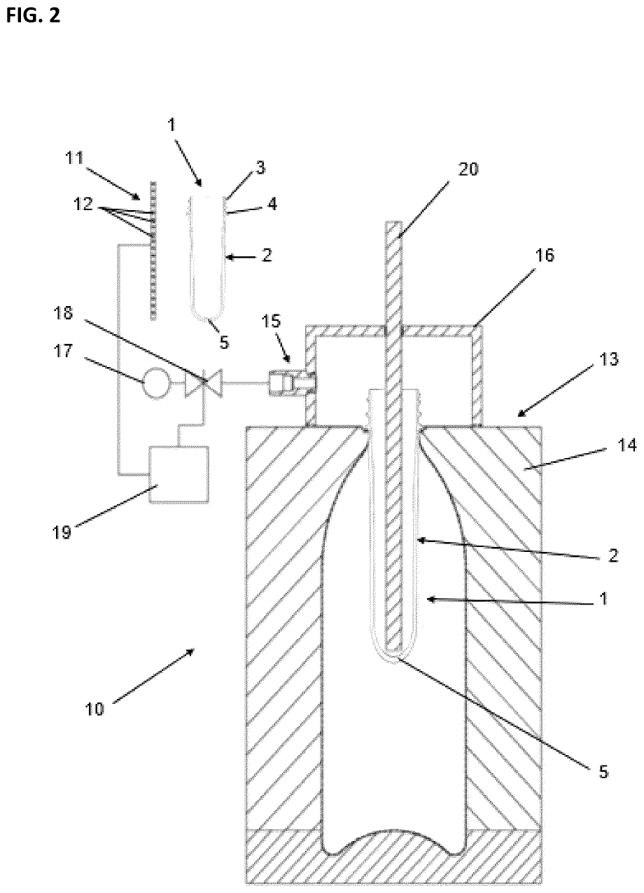

Moreover, FIG. 2 very schematically shows an installation 10 for manufacturing a container from a preform 1, as described above.

This installation 10 comprises a heating unit 11 provided with a plurality of sources 12 of monochromatic or quasi-monochromatic electromagnetic radiation in the infrared range.

In theory, a monochromatic source is an ideal source emitting a sinusoidal wave of a single frequency. In other words, its frequency spectrum consists of a single line of zero spectral width (Dirac).

A source of this kind does not exist in practice; a real source is at best quasi-monochromatic, i.e. its frequency spectrum extends over a band of small but non-zero spectral width, centered on a main frequency at which the radiation intensity is maximal.

The sources 12 are preferably arranged in an array; they are, for example, VCSEL-type laser diodes, each emitting radiation with a power of some tens of milliwatts at a wavelength in the order of 1 μm.

The installation 10 also comprises a forming unit 13 including at least one mold 14 with the impression of the container. In practice, the forming unit 13 may comprise a series of molds 14 mounted on a rotary carousel. The forming unit 13 comprises, for each mold 14, an injection device 15 comprising a nozzle 16 configured to be applied in a sealed manner against an upper face of the mold 14 and connected to a source 17 of pressurized fluid (e.g. air) via a distributor 18 (e.g. a solenoid valve). The installation furthermore comprises a control unit 19 connected to the sources 17 and to the distributor 18 to control, respectively, the pressure setting, opening and closing thereof.

In the illustrated example, the forming unit 13 further comprises, for each mold 14, a rod 20 mounted so as to slide relative to the mold 14, in order to ensure, simultaneously with the blowing, stretching of the preform 1.

Hence, the following procedure is followed to form a container.

First, a preform 1 as described above is supplied, for example from a container in which identical preforms 1 are stored.

The body 2 and the base 5 of the preform 1 are then heated in the heating unit 11 by exposure to monochromatic or quasi-monochromatic infrared radiation of predetermined intensity emitted by the sources 12. During heating, the preform 1 is rotated about its axis X, in order to ensure uniform exposure, or otherwise, of its body 2 and its base 5 to the radiation.

In view of its shape and dimensions, as described above, it is observed that the preform 1 refracts little of the radiation that it receives. This results in better energy distribution within the material, improved control of heating and better correspondence between the power profile set at the sources 12 and the actual thermal profile observed (e.g. by means of a thermal camera) on the preform 1.

The preform 1 heated in this manner is then introduced into the mold 14 and the container is formed by injecting a pressurized fluid (e.g. air) from the source 17 into the preform 1.

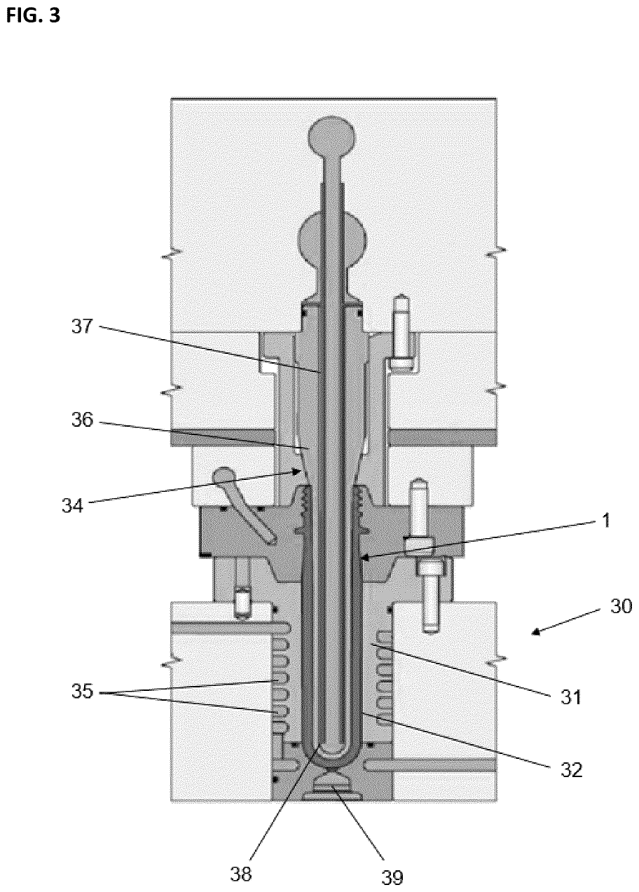

The forming by injection may comprise a step of axial stretching of the preform 1 by means of a rod (cf. rod 20 in FIG. 3).

As an alternative, the forming may be carried out freely, that is to say without a mold 14.

Moreover, FIG. 3 partially shows a mold 30 for forming a preform 1 as described above.

More specifically, the illustrated mold 30 is advantageously designed to enable the manufacture of the preform 1 shown in FIG. 1, by simple injection of a plastics material (typically PET and/or rPET). A mold 30 of this kind comprises, on the one hand, a mold body 31 having a lateral wall 32 with the impression of the outer face of the preform 1 in the region of the body 2 and a mold base 33 with the impression of the outer face of the preform 1 in the region of the base 5, and, on the other hand, a core 34 with the impression of the inner face of the preform 1.

The mold body 31 and the mold base 33 are fixed, whereas the core 34 is translatable relative thereto so as to allow the preform 1, once formed, to be removed and stripped.

As shown in FIG. 3, the lateral wall 32 and the mold base 33 are provided, on their periphery, with grooves 35 which, together with an outer shell (not shown), form circulation channels for a refrigerant fluid (such as water) intended to cool the preform 1, via its outer face, immediately after it has been formed.

As can also be seen in FIG. 3, the core 34 is provided with a hollow outer shell 36 with the impression of the inner face of the preform 1, and with a central injector 37, likewise hollow, provided at a lower end with cut-outs 38. A refrigerant fluid (such as water) introduced into the injector 37 passes through the cut-outs 38 and circulates between the injector 37 and the shell 36, in order to regulate the temperature thereof to a moderate value and thereby cool the preform 1, via its inner face, immediately after it has been formed.

The material (e.g. PET and/or rPET) is introduced in molten form, by means of an injection device (not shown) through a hole 39 made at the centre of the mold base 33.

It will be noted that, as an alternative, the preform 1 may be formed by techniques other than simple injection, in particular injection-compression.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

1. A plastic preform for manufacturing containers by stretch-blow molding, comprising at least:
a body that is rotationally symmetrical about a vertical central axis, the body having an outer wall and an inner wall, a radial distance between the outer wall and the inner wall defining a wall thickness;
an open neck that extends as a continuation of the body from an upper end thereof, the neck being separated from the body by an annular collar; and
a base that closes the body from a lower end thereof, the base being rotationally symmetrical about the central axis;
wherein the body has a substantially cylindrical shape in which the wall thickness increases from the collar towards the base over a cone height Hc, the cone height Hc being a mean of a cone height Hc₁ of the outer wall of the body and a cone height Hc₂ of the inner wall of the body,
the body comprising a first wall thickness E2 under the collar at an under-neck reference height Hr, a second wall thickness E of at the cone height Hc, and a third wall thickness E1 at the lower end of the body, such that the third wall thickness E1 is between 0.7 E and 1.2 E and such that the first wall thickness E2 is between 0.5 E and 1.0 E, wherein the second wall thickness E corresponds to the greatest thickness of the wall of the body at the cone height Hc₁ or Hc₂.

2. The preform according to claim 1, wherein the under-neck reference height Hr is between 1.0 E2 and 4.0 E2.

3. The preform according to claim 1, wherein, over the cone height Hc, a mean external diameter D1 of the body increases from the collar towards the lower end of the body.

4. The preform according to claim 3, wherein, over the height Hc, a mean internal diameter D2 of the body is constant from the collar towards the lower end of the body.

5. The preform according to claim 1, wherein, over the cone height Hc, a mean external diameter D1 of the body is constant from the collar towards the lower end of the body.

6. The preform according to claim 5, wherein, over the height Hc, a mean internal diameter D2 of the body decreases from the collar towards the lower end of the body.

7. The preform according to claim 1, wherein, over the height Hc, a mean external diameter D1 of the body decreases from the collar towards the lower end of the body and a mean internal diameter D2 of the body decreases from the collar towards the lower end of the body, the mean internal diameter D2 decreasing more rapidly than the mean external diameter D1.

8. The preform according to claim 1, wherein the base has a substantially hemispherical shape.

9. The preform according claim 1, wherein the base has a wall thickness less than or equal to the third wall thickness E1 of the body of the preform.

10. A method for manufacturing a container by blow molding or stretch-blow molding, comprising at least the following steps:
providing a preform;
heating the body of the preform by exposure to monochromatic or quasi-monochromatic infrared radiation of predetermined intensity to form a preheated preform; and
forming the container by injecting a pressurized fluid into the preheated preform,
wherein the preform comprises:
a body that is rotationally symmetrical about a vertical central axis, the body having an outer wall and an inner wall, a radial distance between the outer wall and the inner wall defining a wall thickness;
an open neck that extends as a continuation of the body from an upper end thereof, the neck being separated from the body by an annular collar; and
a base that closes the body from a lower end thereof, the base being rotationally symmetrical about the central axis;
wherein the body has a substantially cylindrical shape in which the wall thickness increases from the collar towards the base over a cone height Hc, the cone height Hc being a mean of a cone height Hc₁ of the outer wall of the body and a cone height Hc₂ of the inner wall of the body,
the body comprising a first wall thickness E2 under the collar at an under-neck reference height Hr, a second wall thickness E of at the cone height Hc, and a third wall thickness E1 at the lower end of the body, such that the third wall thickness E1 is between 0.7 E and 1.2 E and such that the first wall thickness E2 is between 0.5 E and 1.0 E, wherein the second wall thickness E corresponds to the greatest thickness of the wall of the body at the cone height Hc₁ or Hc₂.

11. The method according to claim 10, wherein between the heating step and the forming step, the method comprises a step of introducing the preform into a mold comprising an impression of the container.

12. A mold for forming a preform, the mold comprising at least:
a mold body having a lateral wall with an impression of an outer face of a body of the preform and a mold base with an impression of an outer face of the base of the preform and a core with an impression of an inner face of the preform,
wherein the preform comprises:
the body, the body being rotationally symmetrical about a vertical central axis, the body having an outer wall and an inner wall, a radial distance between the outer wall and the inner wall defining a wall thickness;
an open neck that extends as a continuation of the body from an upper end thereof, the neck being separated from the body by an annular collar; and
the base, wherein the base closes the body from a lower end thereof, the base being rotationally symmetrical about the central axis;
wherein the body has a substantially cylindrical shape in which the wall thickness increases from the collar towards the base over a cone height Hc, the cone height Hc being a mean of a cone height Hc₁ of the outer wall of the body and a cone height Hc₂ of the inner wall of the body,
the body comprising a first wall thickness E2 under the collar at an under-neck reference height Hr, a second wall thickness E of at the cone height Hc, and a third wall thickness E1 at the lower end of the body, such that the third wall thickness E1 is between 0.7 E and 1.2 E and such that the first wall thickness E2 is between 0.5 E and 1.0 E, wherein the second wall thickness E corresponds to the greatest thickness of the wall of the body at the cone height Hc₁ or Hc₂.
